(19) United States
(12) Patent Application Publication
(10) Pub. No.: US 2012/0089978 A1
(43) Pub. Date: Apr. 12, 2012

(54) METHOD FOR MANAGING APPLICATIONS OF PORTABLE DEVICES

(75) Inventors: Gary Kung, Santa Ana, CA (US); Johnny Chen, Santa Ana, CA (US)

(73) Assignee: I O INTERCONNECT, LTD., Santa Ana, CA (US)

(21) Appl. No.: 13/099,294

(22) Filed: May 2, 2011

Related U.S. Application Data
(60) Provisional application No. 61/392,445, filed on Oct. 12, 2010.

(51) Int. Cl. G06F 15/16; G06F 9/445

(52) U.S. Cl. 717/178; 709/203

(57) ABSTRACT

A method for managing applications of a portable device by a computer electrically connected to the portable device is provided, wherein the computer connects to the internet. Application information from websites is obtained by the computer after the portable device is recognized, wherein the application information is obtained by analyzing the applications of the portable device. According to the application information, an application is downloaded from the websites to the portable device through the Internet connection of the computer and not the Internet connection of the portable device. The downloaded application is provided to the devices other than the portable device by the computer through the internet.

### CROSS REFERENCE TO RELATED APPLICATIONS

This application claims the benefit of U.S. Provisional Application No. 61/392,445, filed on Oct. 12, 2010, the entirety of which is incorporated by reference herein.

### BACKGROUND OF THE INVENTION

1. Field of the Invention

The present invention is related to a method for managing applications of portable devices, and more particularly to a method for managing applications of portable devices through a computer.

2. Description of the Related Art

Along with the advancement of electronic technology, various portable devices, that are able to provide many different applications (apps), have been developed and brought into the market in order to meet consumers' requirements, wherein the applications that run on the portable devices (such as mobile phones, personal digital assistants (PDAs) and other hand-held devices) are referred to as mobile applications.

In general, mobile applications are either pre-installed on the portable devices during the manufacturing thereof, or downloaded/installed by users from application stores or mobile software distribution platforms. However, a portable device must connect to the internet to link to the websites of the application stores or the mobile software distribution platforms, so as to download/install the applications from the websites to the portable device, thus increasing data transmission charges for the portable device.

Therefore, a method for downloading new applications without data transmission charge is desired.

### BRIEF SUMMARY OF THE INVENTION

An embodiment of a method for managing applications of a portable device is provided. A portable device is electrically connected to a computer, wherein the computer connects to the internet. The type of the portable device is recognized by the computer. Applications of the portable device are classified and a classification result is obtained by the computer. Recommended application information is displayed on a screen of the computer according to the classification result, wherein the recommended application information is obtained from a website through the internet.

Furthermore, another embodiment of a method for managing applications of a portable device is provided. A portable device is electrically connected to a computer, wherein the computer connects to the internet. Recommended application information from a website through the internet is displayed on a screen of the computer according to a classification result, wherein the classification result indicates the categories of preference applications for the portable device. An application is downloaded or installed from the website to the portable device through the computer and the internet according to the recommended application information.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a schematic diagram illustrating communications between a computer and a portable device according to an embodiment of the invention, wherein the computer connects to the internet;

FIG. 2 shows a method for managing applications (apps) of a portable device according to an embodiment of the invention;

FIG. 3 shows an example illustrating a window displayed on a screen of the computer in FIG. 1;

FIG. 4 shows an example illustrating a window displayed on a screen of the computer in FIG. 1;

FIG. 5 shows a schematic diagram illustrating the computer and a mass storage device according to an embodiment of the invention; and

FIG. 6 shows an example illustrating a window displayed on the screen of the computer connected to the mass storage device according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

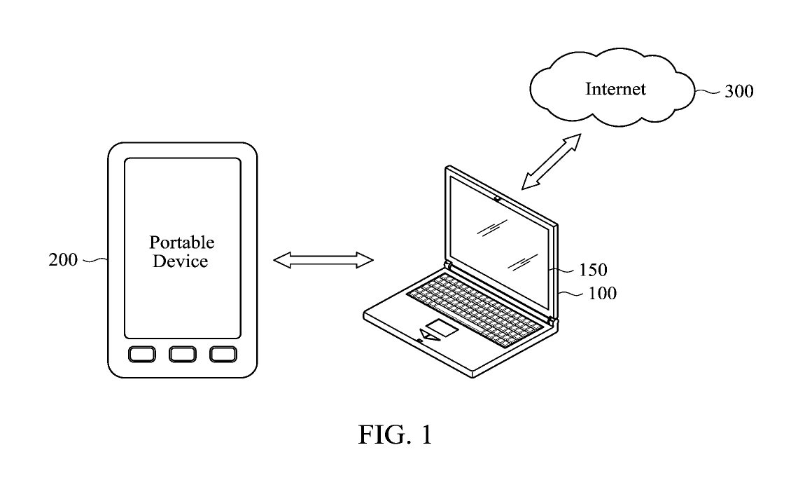

FIG. 1 shows a schematic diagram illustrating communications between a computer 100 and a portable device 200 according to an embodiment of the invention, wherein the computer 100 connects to the internet 300. The portable device 200 may be a hand-held phone or a tablet computer, which has a specific operating system (OS), such as an Android OS, iOS, or webOS and so on. The portable device 200 is electrically connected to the computer 100 by a wired manner (e.g. USB) or a wireless manner (e.g. BT or WiFi).

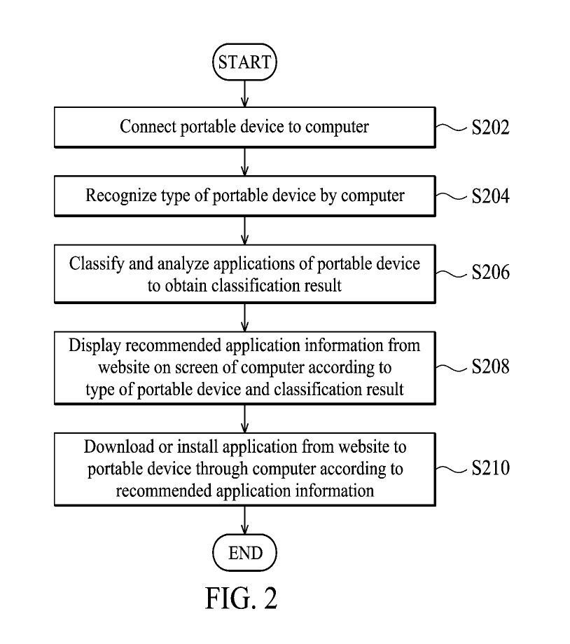

FIG. 2 shows a method for managing applications (apps) of a portable device according to an embodiment of the invention. Referring to FIG. 1 and FIG. 2 together, first, in step S202, the portable device 200 is electrically connected to the computer 100, wherein the computer 100 connects to the Internet 300. Next, in step S204, the computer 100 may recognize the type of the portable device 200 according to identification information provided by the portable device 200, so as to recognize the OS of the portable device 200 according to the type of the portable device 200. In one embodiment, the identification information of the portable device 200 comprises a Vendor ID (VID) and a Product ID (PID). If the computer 100 does not recognize the identification information of the portable device 200, the computer 100 may automatically link to specific websites through the Internet 300 according to the identification information of the portable device 200, so as to gather information corresponding to the identification information of the portable device 200 for accomplishing the recognition procedure. For example, the computer 100 may link to a website which provides various device drivers and then the computer 100 may download a device driver corresponding to the identification information of the portable device 200, thus accomplishing recognition of the portable device 200.

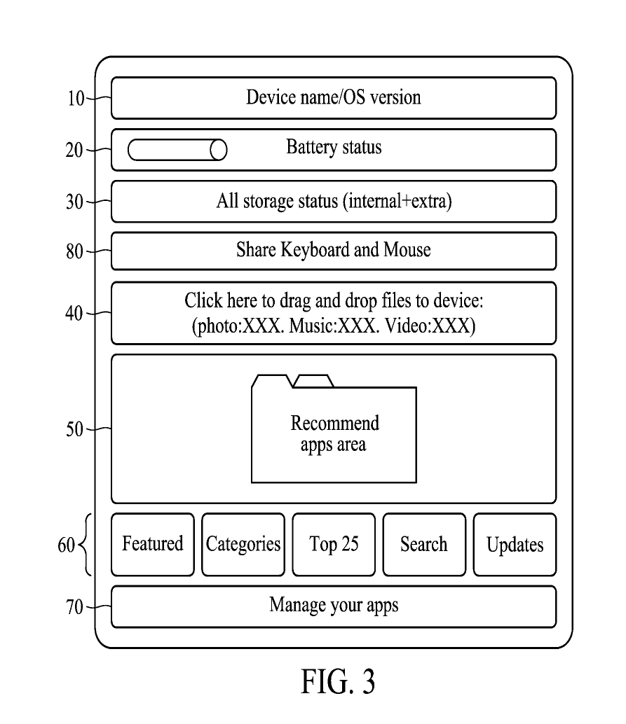

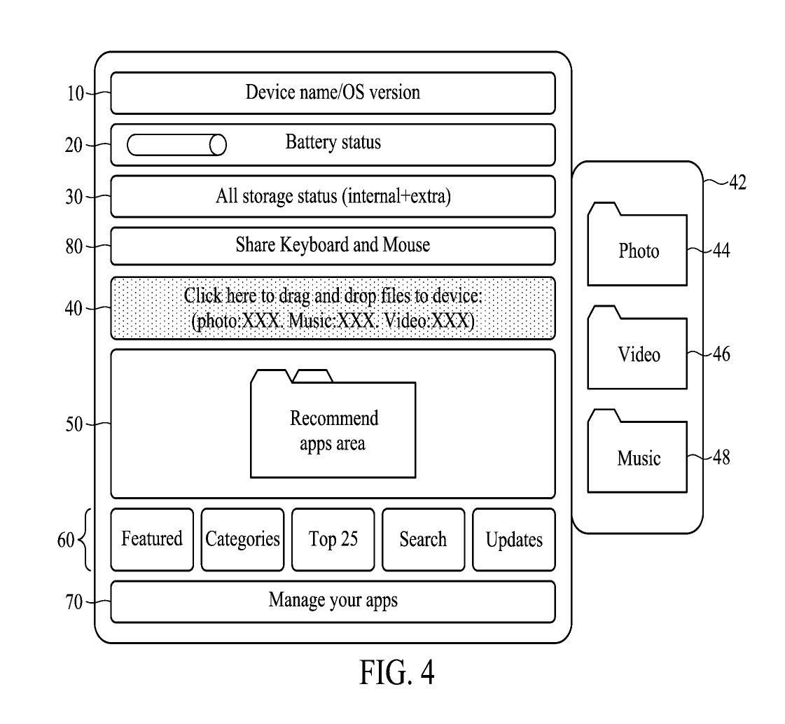

When the portable device 200 is recognized, the computer 100 may classify the applications of the portable device 200 and analyze the classified applications to obtain a classification result that indicates which categories are the preferences for the user (step S206), such as games, entertainment, sports and so on. When the portable device 200 is recognized, the information regarding the portable device 200 is displayed on a screen 150 of the computer 100 in FIG. 1. For example, FIG. 3 shows an example illustrating a window displayed on the screen 150 of the computer 100 in FIG. 1. Referring to FIGS. 1-3 together, after the portable device 200 is recognized, the computer 100 displays the information and status of the portable device 200 on the screen 150, such as device name/OS version (e.g. button 10 of FIG. 3), battery status (e.g. button 20 of FIG. 3), storage capacity (e.g. button 30 of FIG. 3) and so on. Furthermore, if the OS of the portable device 200 is an android system, the computer 100 may share its keyboard and mouse with the portable device 200 when the “share keyboard and mouse” function is clicked, as shown for button 80 of FIG. 3. Furthermore, the computer 100 may link to the websites which provide various applications through the Internet 300 without loading any web page, so as to obtain suitable application information from the websites according to the OS of the portable device 200 (step S208), wherein the suitable application information indicates that the applications are compatible with the portable device 200, i.e. the applications can be executed in the OS of the portable device 200. Next, in step S210, the computer 100 may display recommendation application information, as shown for button 50 of FIG. 2, for user reference, wherein the recommended application information obtained from the suitable application information according to the classification result, records the applications that the user is interested in, i.e. the categories of preference applications. In one embodiment, the recommended application information is directly obtained from the websites according to the OS of the portable device 200 and the classification result. Next, the applications corresponding to the recommended application information shown in the recommend application area (e.g. 50 of FIG. 4) may be chosen to be downloaded or installed to the portable device 200 through the computer 100 (step S212). Thus, a new application is downloaded or installed from the website to the portable device 200 through the internet 300 and the computer 100.

It is to be noted that the portable device 200 does not directly access the internet and link to the website, thereby, no data transmission charge is charged to the portable device 200. Furthermore, in general, a screen of a computer has a larger size than a portable device, thus it is more comfortable for a user to manage the applications of the portable device through the computer. By analyzing the categories of the applications of the portable device 200, the computer 100 may directly provide the application information that the user is interested in, thus saving time for the user to search for interested applications.

The computer 100 further provides a button, such as button 70, for the user to manage the applications of the portable device 200 through the computer 100. In addition to managing the applications of the portable device 200, the computer 100 further provides a button, such as button 40, for the user to manage the files of the portable device 200. For example, if the “drag and drop” function is clicked, as shown in FIG. 4, the computer 100 may automatically open a sub-window 42 which exhibits the folders (e.g. photo folder 44, video folder 46 and music folder 48) of the portable device 200 on the screen 150. Thus, the user may directly access and manage the files in the portable device 200 through the folders in the sub-window 42. Furthermore, the user may further add or update the files of the computer 100 to the portable device 200. For example, the user may drag a file of the computer 100 and drop the dragged file into the folder of the sub-window 42. In addition, before transmitting the file to the portable device 200, the computer 100 may query the user whether to convert the file to be transmitted. Taking a video file as an example, the computer 100 first detects information of the video file, such as format type and resolution, and then displays the detected information for user reference. Next, the computer 100 converts the video file according to user confirmation, and transmits the converted video file to the designate folder of the portable device 200. For example, if the resolution of the video file exceeds 720 p, the user may request the computer 100 to convert the video file due to the portable device 200 being unable to view the video file. If the OS of the portable device 200 is an iOS or webOS system, the computer 100 needs to install a PC widget to the portable device 200 when the “drag and drop” function is clicked, so as to transmit the file from the computer 100 to the portable device 200.

In one embodiment, before downloading or installing a new application from the website to the portable device 200 through the computer 100 and the internet 300, a trial application corresponding to the new application may be downloaded and installed in the computer 100, and then the user may perform the trial application in the computer 100, so as to determine whether to download or install the new application to the portable device 200.

In order to simplify the display setting and display the recommendation application information in the area 50 of FIG. 4 quickly, the computer 100 further provides various function buttons (e.g. 60 of FIG. 4) according to a predefined setting, to show the application information corresponding to the function buttons. For example, the user may set the function buttons according to characters of the applications, such as “feature”, “category”, “billboard” or “new arrivals”.

When the applications are downloaded to the computer 100 for storage or installation to the portable device 200, the computer 100 may share the downloaded applications or the application information thereof to other devices through the internet 300 with Email, Short message services (SMS), and social network means and so on.

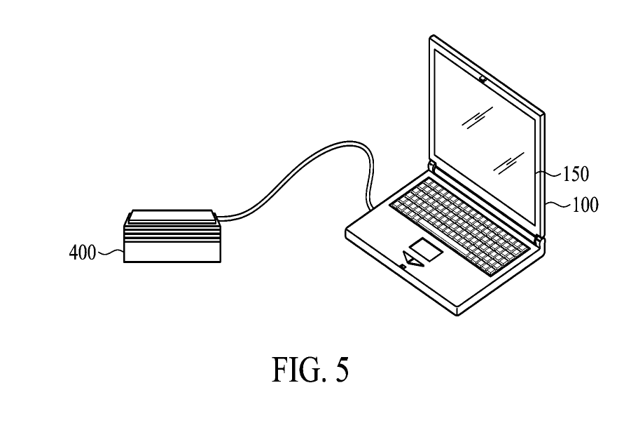

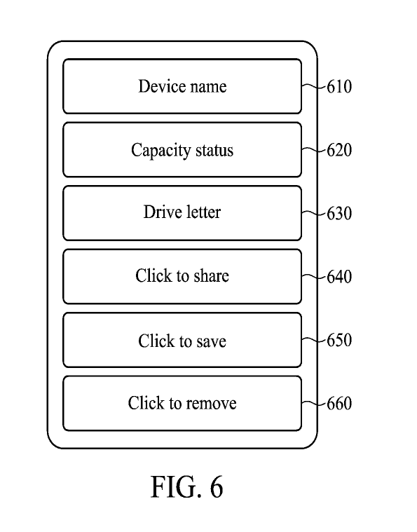

According to an embodiment of the invention, the applications that are downloaded or installed from the websites to the portable device may be backed up/stored to mass storage devices through the computer 100. Referring to FIG. 5, it shows a schematic diagram illustrating the computer 100 and a mass storage device 400 according to an embodiment of the invention. Similarly, when the mass storage device 400 is electrically connected to the computer 100, the computer 100 will recognize the kind/type of the mass storage device 400, such as a hard disc (HD) or a flash memory, and then the information and status of the mass storage device 400 (e.g. device name 610 and capacity status 620 of FIG. 6) are displayed on the screen 150 of the computer 100, as shown in FIG. 6. FIG. 6 shows an example illustrating a window displayed on the screen 150 of the computer 100 connected to the mass storage device 400 according to an embodiment of the invention. After the mass storage device 400 is recognized, applications or files may be transferred between the mass storage device 400 and the computer 100 by using the predefined button functions. For example, the “Drive letter” button 630 is used to open a sub-window to display the folders of the mass storage device 400, the “Click to share” button 640 is used to upload the designated applications from the folders of the mass storage device 400 to the computer 100, the “Click to save” button 650 is used to download the designated applications from the computer 100 to the folders of the mass storage device 400, and the “Click to remove” button 660 is used to delete the designate applications from the folders of the mass storage device 400.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for managing applications of portable devices, comprising:
electrically connecting a portable device to a computer, wherein the computer connects to the internet;
recognizing a type of the portable device by the computer;
classifying applications of the portable device and obtaining a classification result by the computer; and
displaying recommended application information on a screen of the computer according to the classification result, wherein the recommended application information is obtained from a website through the internet.

2. The method as claimed in claim 1, further comprising:
downloading or installing an application from the website to the portable device through the computer and the internet according to the recommended application information.

3. The method as claimed in claim 2, further comprising:
providing the application or the recommended application information from the computer to the devices other than the portable device through the internet.

4. The method as claimed in claim 2, further comprising:
electrically connecting a mass storage device to the computer;
displaying information and status of the mass storage device on the screen of the computer; and
transferring the application between the computer and the mass storage device.

5. The method as claimed in claim 2, wherein the step of downloading or installing the application from the website to the portable device through the computer further comprises:
downloading or installing a trial application corresponding to the application from the website to the computer through the internet; and
performing the trial application, so as to determine whether to download or install the application from the website to the portable device.

6. The method as claimed in claim 1, further comprising:
displaying information and status of the portable device on the screen of the computer according to the type of the portable device.

7. The method as claimed in claim 1, wherein the step of recognizing the type of the portable device by the computer further comprises:
obtaining identification information of the portable device;
obtaining the type of the portable device when the identification information is recognized; and
recognizing an operating system of the portable device according to the type of the portable device.

8. The method as claimed in claim 7, wherein the step of recognizing the type of the portable device by the computer further comprises:
linking to a specific website through the internet according to the identification information when the identification information has not been recognized;
gathering information corresponding to the identification information from the specific website; and
recognizing the type of the portable device according to the gathered information.

9. The method as claimed in claim 7, wherein the step of displaying the recommended application information further comprises:
linking to the website by the computer through the internet;
obtaining suitable application information by the computer according to the operating system of the portable device; and
obtaining the recommended application information from the suitable application information according to the classification result.

10. The method as claimed in claim 7, wherein the step of displaying the recommended application information further comprises:
linking to the website by the computer through the internet; and
obtaining the recommended application information from the suitable application information according to the operating system of the portable device and the classification result.

11. The method as claimed in claim 7, further comprising:
sharing a keyboard and a mouse of the computer to the portable device when the operating system of the portable device is an android system.

12. The method as claimed in claim 1, wherein the step of displaying the recommended application information further comprises:
displaying the recommended application information with specific characters on the screen of the computer, wherein the specific characters are designated according to a predefined setting of the computer.

13. The method as claimed in claim 1, wherein the classification result indicates the categories of preference applications for the portable device.

14. The method as claimed in claim 1, further comprising:
transmitting a designated file of the computer to the portable device; and
before transmitting the designated file, converting the designated file to a suitable format when the designated filet has a specific format that the portable device does not support.

15. A method for managing applications of portable devices, comprising:
electrically connecting a portable device to a computer, wherein the computer connects to the internet;
displaying recommended application information from a website through the internet, on a screen of the computer according to a classification result, wherein the classification result indicates the categories of preference applications for the portable device; and
downloading or installing an application from the website to the portable device through the computer and the internet according to the recommended application information.

16. The method as claimed in claim 15, further comprising:
providing the application or the recommended application information from the computer to the devices other than the portable device through the internet.

17. The method as claimed in claim 15, further comprising:
electrically connecting a mass storage device to the computer;
displaying information and status of the mass storage device on the screen of the computer; and
transferring the application between the computer and the mass storage device.

18. The method as claimed in claim 15, further comprising:
recognizing a type of the portable device by the computer; and
displaying information and status of the portable device on the screen of the computer according to the type of the portable device.

19. The method as claimed in claim 18, wherein the step of recognizing the type of the portable device by the computer further comprises:
obtaining identification information of the portable device;
obtaining the type of the portable device when the identification information is recognized; and
recognizing an operating system of the portable device according to the type of the portable device.

20. The method as claimed in claim 19, wherein the step of recognizing the type of the portable device by the computer further comprises:
linking to a specific website through the internet according to the identification information when the identification information has not been recognized;
gathering information corresponding to the identification information from the specific website; and
recognizing the type of the portable device according to the gathered information.

21. The method as claimed in claim 19, wherein the step of displaying the recommended application information further comprises:
linking to the website by the computer through the internet;
obtaining suitable application information by the computer according to the operating system of the portable device; and
obtaining the recommended application information from the suitable application information according to the classification result.

22. The method as claimed in claim 19, wherein the step of displaying the recommended application information further comprises:
linking to the website by the computer through the internet; and
obtaining the recommended application information from the suitable application information according to the operating system of the portable device and the classification result.

23. The method as claimed in claim 19, further comprising:
sharing a keyboard and a mouse of the computer to the portable device when the operating system of the portable device is an android system.

24. The method as claimed in claim 15, wherein the step of displaying the recommended application information further comprises:
displaying the recommended application information with specific characters on the screen of the computer, wherein the specific characters are designated according to a predefined setting of the computer.

25. The method as claimed in claim 15, wherein the step of downloading or installing the application from the website to the portable device through the computer further comprises:
downloading or installing a trial application corresponding to the application from the website to the computer through the internet; and
performing the trial application, so as to determine whether to download or install the application from the website to the portable device.

26. The method as claimed in claim 15, further comprising:
transmitting a designated file of the computer to the portable device; and
before transmitting the designated file, converting the designated file to a suitable format when the designated filet has a specific format that the portable device does not support.
